(19) United States
(12) Patent Application Publication
(10) Pub. No.: US 2018/0273763 A1
(43) Pub. Date: Sep. 27, 2018

(54) DISPERSANT AND PRINTING INK COMPOSITION

(71) Applicant: Seiko Epson Corporation, Tokyo (JP)

(72) Inventors: Yoshifumi ITO, Matsumoto (JP); Tomohiro FUJITA, Chino (JP); Toshiki HARA, Suwa (JP); Yukiko II, Suwa (JP)

(21) Appl. No.: 15/827,386

(22) Filed: Nov. 30, 2017

(30) Foreign Application Priority Data
Mar. 21, 2017 (JP) 2017-054389

(51) Int. Cl. C09B 67/46; C09D 11/03; C09D 11/30

(52) U.S. Cl. CPC C09B 67/0089; C09D 11/30; C09D 11/03

(57) ABSTRACT

A printing ink composition contains a disperse dye, a dispersant, and water, in which the dispersant contains one or more compounds represented by:

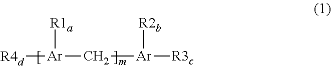

wherein each Ar independently represents an aromatic ring having 6 to 24 carbon atoms, R1 and R2 independently represent a substituent selected from the group consisting of H, OCH₃, OH, COOH, SO₃H, OSO₃H, an alkyl group having 1 to carbon atoms, and a salt thereof, R3 represents a substituent selected from the group consisting of OH, COOH, SO₃H, OSO₃H, and a salt thereof, R4 represents a substituent selected from the group consisting of H, OCH₃, OC₂H₅, an alkyl group having 1 to 3 carbon atoms, and a salt thereof, the substituent introduction numbers a, b, c, and d each represent an integer of 1 to 8, and the number of repetitions m represents an integer of 1 to 50.

### BACKGROUND

### 1. Technical Field

The present invention relates to a dispersant and a printing ink composition.

### 2. Related Art

An ink jet recording method enables recording of a high definition image with a relatively simple apparatus and has rapidly developed in various fields. In the development, a disperse dye has been variously examined for the ejection stability and the like. For example, JP-A-8-291266 aims at providing an ink jet ink having an excellent blurring prevention effect and improving nozzle clogging in a non-operating state of an apparatus or the cleaning properties of an ink passage in printing of cloth by ink jet, and discloses an ink jet ink obtained by dispersing a substantially water-insoluble dye or pigment in a aqueous solvent, in which the ink jet ink contains, as a dispersant, an aromatic polyvalent anionic dispersant which is a formalin condensate of an aromatic sulfonic acid salt having any one of a hydroxyl group, an ether group, an amino group, and an imino group and one or more kinds selected from an aromatic sulfonic acid salt and an aromatic compound.

In manufacturing of a former disperse dye ink, a water-insoluble or hardly-soluble disperse dye ground into several tens of nm to submicron size with a mill or the like is dispersed into an aqueous solvent using a dispersant in a dispersion process. In order to maintain a good dispersion state without causing precipitation of the disperse dye in the aqueous solvent or the generation of foreign substances originating from the disperse dye, a dispersant excellent in compatibility (or dispersibility) with both the aqueous solvent and the disperse dye is required.

In general, the solubility of a disperse dye by a dispersant varies depending on the temperature of a solvent. Therefore, when an ink is stored in various temperature environments from low temperatures to high temperatures, a composition change of a solvent component due to a difference between the high temperature dissolution amount and the low temperature dissolution amount sometimes occurs. Moreover, in the vicinity of a nozzle, drying of a low boiling point component of ink components or a composition change of a solvent component in connection therewith sometimes occurs.

Thus, an ink stored under a high temperature over a long period of time or an ink in the vicinity of a nozzle has had problems that the composition balance of components in the ink changes, so that the dispersion stability of the disperse dye is impaired, which causes an increase in the particle diameter of the disperse dye or the generation of foreign substances originating from the disperse dye.

As the dispersant for the disperse dye, dispersants, such as naphthalene sulfonic acid and lignin sulfonic acid, have been used until now. These dispersants have been used as a dispersant by sulfonating compounds derived from coal, such as naphthalene, anthracene, and phenanthrene, forming a formalin condensate by formaldehyde, and then polymerizing the formalin condensate (JP-A-8-291266). However, with such dispersants in which the constitution units of the polymer are only sulfonated, it has been difficult to control the polarity value to various polarity values and it has been difficult to sufficiently maintain the dispersion stability of the disperse dyes having various polarity values when stored at a high temperature over a long period of time.

### SUMMARY

The present invention has been made in order to at least partially solve the above-described problems. An advantage of some aspects of the invention is to provide a printing ink composition excellent in dispersion stability of a disperse dye even when stored at a high temperature over a long period of time.

The present inventors have conducted an extensive examination in order to solve the above-described problems. As a result, the present inventors have found that the above-described problems can be solved by using a plurality of dispersants having a desired polarity (retention time) in combination so as to include the polarity (retention time) range of a disperse dye.

More specifically, the present invention is a printing ink composition containing a disperse dye, a dispersant, and water, in which the dispersant contains one or more compounds represented by the following formula (1),

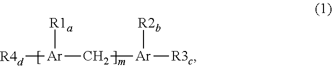

wherein, in Formula 1, Ars each independently represent an aromatic ring having 6 to 24 carbon atoms, R1 and R2 each independently represent a substituent (an electron attracting group or an electron donating group) selected from the group consisting of H, OCH₃, OH, COOH, SO₃H, OSO₃H, an alkyl group having 1 to 6 carbon atoms, and a salt thereof, R3 represents a substituent (electron attracting group) selected from the group consisting of OH, COOH, SO₃H, OSO₃H, and a salt thereof, R4 represents a substituent (electron donating group) selected from the group consisting of H, OCH₃, OC₂H₅, an alkyl group having 1 to 3 carbon atoms, and a salt thereof, the substituent introduction numbers a, b, c, and d each independently represent an integer of 1 to 8, and the number of repetitions m represents an integer of 1 to 50.

It is preferable that the range of the retention time of the dispersant includes a range from the retention time of 1.5 to the upper limit of the retention time of the disperse dye, the mass ratio (Total dispersant amount/Disperse dye) of the total dispersant amount to the disperse dye is in the range of 1/10 to 10, and the aromatic ring is any one of a benzene ring, a naphthalene ring, an anthracene ring, and a phenanthrene ring.

### DESCRIPTION OF EXEMPLARY EMBODIMENTS

An embodiment of the present invention (hereinafter referred to as “this embodiment”) is described in detail but the present invention is not limited thereto and can be variously modified without deviating from the scope thereof. Printing ink composition

A printing ink composition of this embodiment contains a disperse dye, a dispersant, and water, in which the dispersant contains one or more compounds represented by Formula (1) described later.

### Dispersant

The dispersant of this embodiment contains a compound represented by the following formula (1). With respect to the dispersant of this embodiment, the polarity (retention time) of the dispersant can be easily adjusted and the affinity for both the disperse dye and an aqueous solvent is improved by adjusting the type (electron attracting group, electron donating group) and the introduction amount (number of substituents) of substituents in the compound represented by Formula (1). In detail, a dispersant into which an electron donating group is introduced has a tendency that the polarity is low and the retention time increases and a dispersant into which an electron attracting group is introduced has a tendency that the polarity is high and the retention time decreases. More specifically, a dispersant having a desired retention time can be obtained by the adjustment of R1, R2, R3, R4, and the number of repetitions m modifying an aromatic ring in the compound of Formula (1). Two or more of the obtained dispersants can be used in combination so as to include the range of the retention time of the disperse dye.

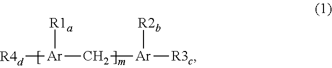

in which, in Formula 1, Ars each independently represent an aromatic ring having 6 to 24 carbon atoms, R1 and R2 each independently represent a substituent (an electron attracting group or an electron donating group) selected from the group consisting of H, OCH3, OH, COOH, SO₃H, OSO₃H, an alkyl group having 1 to 6 carbon atoms, and a salt thereof, R3 represents a substituent (electron attracting group) selected from the group consisting of OH, COOH, SO₃H, OSO₃H, and a salt thereof, R4 represents a substituent (electron donating group) selected from the group consisting of H, OCH₃, OC₂H₅, an alkyl group having 1 to 3 carbon atoms, and a salt thereof, the substituent introduction numbers a, b, c, and d each independently represent an integer of 1 to 8, and the number of repetitions m represents an integer of 1 to 50.

Ars above each independently represent an aromatic ring having 6 to 24 carbon atoms. The aromatic ring is not particularly limited and, for example, a benzene ring, a naphthalene ring, an anthracene ring, and a phenanthrene ring are mentioned.

R1 and R2 each independently represent a substituent selected from the group consisting of H, OCH₃, OH, COOH, SO₃H, OSO₃H, an alkyl group having 1 to 6 carbon atoms, and a salt thereof and, among the above, —SO₃H and a salt thereof are preferable. By the use of such R1 and R2, even when stored at a high temperature over a long period of time, the dispersion stability of the disperse dye tends to be maintained. The substituent introduction numbers a and b of R1 and R2 each independently are an integer of 1 to 8. a is preferably 1 to 5 and more preferably 1 to 3. b is preferably 1 to 5 and more preferably 1 to 3.

R3 represents a substituent (electron attracting group) selected from the group consisting of OH, COOH, SO₃H, OSO₃H, and a salt thereof and, among the above, SO₃H, OSO₃H, and a salt thereof are preferable. By the use of such R3, even when stored at a high temperature over a long period of time, the dispersion stability of the disperse dye tends to be maintained. The substituent introduction number c of R3 is an integer of 1 to 8. c is preferably 1 to 5 and more preferably 1 to 3.

R4 represents a substituent (electron donating group) selected from the group consisting of H, OCH₃, OC₂H₅, and an alkyl group having 1 to 3 carbon atoms and, among the above, H and OCH₃ are preferable. By the use of such R4, even when stored at a high temperature over a long period of time, the dispersion stability of the disperse dye tends to be maintained. The substituent introduction number d of R4 is an integer of 1 to 8. d is preferably 1 to 5, more preferably 1 to 3, and still more preferably 1.

m representing the number of repetitions of the compound represented by Formula (1) is 1 to 50, preferably 1 to 10, and more preferably 1 to 5. Due to the fact that m is 1 or more, there is a tendency that the polarity of the dispersant is reduced and the affinity for an aqueous solvent further improves. Due to the fact that m is 50 or less, there is a tendency that the polarity of the dispersant is close to the polarity of the disperse dye and the affinity for the disperse dye further improves.

The polarity of the dispersant of this embodiment can be relatively evaluated by measuring the retention time by the following apparatus. The peak top of the component peak of mass spectrometry chromatogram (Ionization method: ESI+/I−) was defined as the retention time. In this specification, the “retention time” refers to one measured under the following measurement conditions.

### Measurement Conditions

Apparatus name: ACQUITY UPLC SYSTEM H-class (manufactured by Waters)
Detector: Mass spectrometer Xevo G2-S QTof (manufactured by Waters)
Used column: ACQUITY UPLC BEH Columns BEH-C18
Particle diameter: 1.7 μm
Filling area: 2.1×100 mm (manufactured by Waters: 186004661)
Developing solvent: Solvent A: 10 mM ammonium bicarbonate aqueous solution
Solvent B: Acetonitrile (for high performance liquid chromatography)

### Separation Conditions (Gradient):

At the time of start Solvent A: 99% Solvent B: 1%

1 minute later Solvent A: 45% Solvent B: 55%

6 minutes later Solvent A: 20% Solvent B: 80%

9 minutes later Solvent A: 6% Solvent B: 94%

The measurement was carried out until the lapse of 15 minutes.

Flow velocity: 0.5 mL/min

The retention time is one index relatively evaluating the molecular polarity of the dispersant of this embodiment. By blending one or more dispersants represented by Formula (1) so as to include the range from the retention time of 1.5 to the upper limit of the retention time of the disperse dye, an improvement effect of the affinity for both the disperse dye and a solvent is appropriately demonstrated, so that the disperse dye can be favorably dispersed in an ink composition. Therefore, even when stored at a high temperature over a long period of time, the dispersion stability of the disperse dye tends to further improve. The range of the retention time of the dispersant in the case of using Raberin W40 having a retention time of 1.0 to 2.5 and a dispersant 1 having a retention time of 2.0 to 4.0 in combination is 1.0 to 4.0. More specifically, in this embodiment, the “range of the retention time” in the case of using a plurality of dispersants is a range of the total retention time of each dispersant. From the viewpoint of including the range of the retention time mentioned above, it is preferable to contain two or more of the dispersants represented by Formula (1).

### Method for Synthesizing Dispersant

As a method for synthesizing a dispersant of this embodiment is not particularly limited and, for example, a method is mentioned which includes adding formaldehyde to an aromatic compound having a substituent, such as H, OCH₃, OH, COOH, SO₃H, OSO₃H, an alkyl group having 1 to 6 carbon atoms, and a salt thereof, and then polymerizing the aromatic compound with formaldehyde.

The used amount of the formaldehyde is not particularly limited and can be set to 0.5 to 1.5 mol based on 1 mol in total of the aromatic compound having the substituent R mentioned above, for example.

The reaction temperature of the polymerization using formaldehyde is not particularly limited and can be set to 90 to 100° C., for example. The addition time of formaldehyde is not particularly limited and can be set to 2 to 3 hours, for example. The reaction time is not particularly limited and can be set to about 10 hours, for example.

As a method for collecting/purifying the dispersant after the reaction is not particularly limited and, for example, a method including removing an unreacted component and a solvent under reduced pressure and other known purifying methods are usable.

Dispersants other than the dispersant described above can also be used in combination. The mass ratio (Total dispersant amount/Disperse dye) of the total dispersant amount to the disperse dye is preferably in the range of 1/10 to 10, more preferably 1/5 to 5, and still more preferably 1/5 to 3. Due to the fact that the mass ratio is within the ranges mentioned above, an improvement effect of the affinity for both the disperse dye and a solvent is appropriately demonstrated and, even when stored at a high temperature over a long period of time, the dispersion stability of the disperse dye tends to further improve.

Furthermore, the total content of the dispersants is preferably 1 to 30% by mass, more preferably 2 to 25% by mass, and still more preferably 3 to 20% by mass based on the total amount of the printing ink composition. The content of each of the dispersants is 0.1 to 30% by mass, more preferably 0.5 to 20% by mass, and still more preferably 1 to 10% by mass based on the total amount of the printing ink composition.

### Disperse Dye

Specific examples of the disperse dye include those mentioned later. When the examples are classified according to the molecular skeleton, an anthraquinone-based compound, an azo-based compound, a naphthalene skeleton containing compound, an azine-based compound, a thiophene-based compound, a thiazole-based compound, a thiazine-based compound, a heterocycle, an acridine skeleton containing compound, a benzoindole-based compound, a coumarin-based compound, a quinoline-based compound, a biphenyl-based compound, a centchroman-based compound, a methine-based compound, a xanthene-based compound, a thioxanthene-based compound, a spirooxazine-based compound, a phthalocyanine-based compound, and a lactone-based compound are mentioned. Among the above, an anthraquinone-based compound, an azo-based compound, and a naphthalene skeleton containing compound are preferable. By the use of such a disperse dye, the affinity between the molecular skeleton of the disperse dye and the aryl group of the dispersant further improves. Even when stored at a high temperature consequently over a long period of time, the dispersion stability of the disperse dye tends to further improve.

It is preferable for the range of the retention time of the dispersant to include the range from the retention time of 1.5 to the upper limit of the retention time of the disperse dye. The retention time of the disperse dye can be measured in the same manner as above. Due to the fact that the range from the retention time of 1.5 to the upper limit of the retention time of the disperse dye is included within the range of the retention time of the dispersant, the dispersion stability of the disperse dye tends to further improve even when stored at a high temperature over a long period of time.

A yellow disperse dye is not particularly limited and, for example, C.I. Disperse Yellow 1, 10, 100, 102, 103, 104, 105, 108, 109, 11, 114, 114, 118, 119, 122, 123, 124, 125, 126, 127, 13, 134, 139, 14, 142, 143, 149, 154, 16, 160, 162, 163, 165, 17, 179, 179, 180, 182, 184, 184:1, 186, 198, 199, 2, 201, 202, 211, 212, 213, 218, 219, 22, 220, 221, 223, 224, 226, 227, 229, 23, 231, 232, 234, 235, 236, 238, 239, 240, 241, 242, 243, 245, 246, 247, 248, 249, 250, 26, 3, 31, 32, 33, 34, 37, 39, 4, 42, 49, 5, 50, 51, 54, 56, 58, 59, 6, 60, 61, 63, 64, 65, 66, 67, 68, 7, 70, 71, 73, 76, 77, 79, 8, 82, 83, 84, 85, 86, 88, 89, 9, 90, 92, 93, 97, 98, and 99 are mentioned.

An orange disperse dye is not particularly limited and, for example, C.I. Disperse Orange 1, 1:1, 10, 11, 119, 121, 127, 13, 136, 138, 149, 15, 152, 157, 17, 18, 20, 21, 23, 24, 25, 25:1, 29, 3, 3:1, 30, 31, 32, 33, 36, 37, 38, 41, 42, 44, 47, 49, 5, 50, 51, 52, 53, 54, 55, 56, 57, 61, 62, 66, 67, 68, 7, 70, 71, 73, 74, 76, 78, 80, 90, 96, and 97 are mentioned.

A red disperse dye is not particularly limited and, for example, C.I. Disperse Red 1, 101, 104, 106, 107, 109, 11, 113, 117, 118, 12, 121, 122, 125, 126, 127, 128, 129, 13, 132, 134, 135, 136, 137, 140, 141, 143, 145, 146, 15, 151, 152, 153, 154, 156, 157, 158, 16, 160, 164, 165, 167, 167:1, 169, 17, 173, 177, 179, 181, 183, 184, 185, 186, 188, 189, 19, 190, 191, 192, 196, 197, 199, 2, 200, 202, 203, 205, 206, 207, 21, 210, 22, 220, 221, 224, 225, 225, 227, 257, 258, 277, 278, 279, 288, 3, 30, 302, 302:1, 303, 305, 307, 31, 313, 319, 32, 321, 322, 323, 331, 334, 338, 339, 340, 343, 349, 354, 356, 362, 364, 367, 370, 372, 376, 377, 378, 379, 381, 382, 383, 384, 4, 41, 43, 5, 50, 53, 54, 55, 56, 58, 59, 6, 60, 63, 64, 65, 7, 70, 71, 72, 73, 74, 75, 76, 78, 8, 82, 86, 88, 9, 90, 91, 92, 97, and 98, C.I. Vat Red 41, C.I. Solvent Red 242, and the like are mentioned.

A violet disperse dye is not particularly limited and, for example, C.I. Disperse Violet 1, 100, 106, 107, 12, 13, 15, 17, 23, 24, 26, 27, 28, 31, 33, 35, 36, 37, 38, 4, 40, 43, 46, 48, 51, 52, 55, 57, 58, 6, 62, 63, 69, 7, 77, 8, 91, 93, 93:1, 95, and 96 are mentioned.

A green disperse dye is not particularly limited and, for example, C.I. Disperse Green 1, 2, 5, 6, 6, 6:1, and 9 are mentioned.

A brown disperse dye is not particularly limited and, for example, C.I. Disperse Brown 1, 1:1, 13, 19, 21, 22, 27, 3, 30, 4, 5, and 9 are mentioned.

A blue disperse dye is not particularly limited and, for example, C.I. Disperse Blue 1, 102, 103, 104, 105, 106, 107, 108, 109, 11, 113, 113, 118, 122, 124, 125, 125, 127, 128, 130, 130, 134, 139, 14, 142, 143, 144, 146, 148, 149, 15, 158, 158, 165, 165: 1, 165:2, 165:2, 166, 167, 167, 167, 173, 174, 175, 176, 180, 181, 183, 183:1, 185, 19, 197, 198, 20, 200, 201, 207, 211, 214, 22, 224, 224, 225, 23, 24, 257, 259, 26 26:1, 264, 266, 268, 27, 270, 270, 28, 281, 284, 285, 287, 291, 295, 297, 297, 297, 3, 301, 31, 316, 319, 324, 327, 328, 334, 335, 337, 338, 339, 34, 342, 344, 35, 354, 356, 359, 360, 361, 365, 366, 367, 375, 376, 377, 378, 379, 38, 380, 40, 5, 54, 56, 58, 6, 60, 62, 64, 64, 7, 72, 73, 75, 75, 77, 79, 79:1, 79:2, 8, 81, 82, 83, 83, 85, 85:1, 87, 87, 9, 90, 91, 94, 95, 96, and 99 are mentioned.

A black disperse dye is not particularly limited and, for example, C.I. Disperse Black 1, 2, 26, 27, 28, 28, 29, 3, 30, 4, 5, 6, 7, and 9 are mentioned.

The content of the disperse dye is preferably 1.0 to 10 parts by mass, more preferably 1.0 to 7.5 parts by mass, and still more preferably 2.5 to 7.5 parts by mass based on the total amount of 100 parts by mass of the printing ink composition.

### Surfactant

The printing ink composition preferably contains a surfactant. The surfactant is not particularly limited and, for example, a silicone-based surfactant, a fluorine-based surfactant, and an acetyleneglycol-based surfactant are mentioned. Among the above, the silicone-based surfactant is preferable.

Commercially-available items of the silicone-based surfactant are not particularly limited, and, specifically, BYK-306, BYK-307, BYK-333, BYK-341, BYK-345, BYK-346, BYK-347, BYK-348, and BYK-349 (All Trade Names, manufactured by BYK Chemie Japan, Inc.), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (All Trade Names, manufactured by Shin-Etsu Chemical Co., Ltd.), and the like are mentioned. The silicone-based surfactants may be used alone or in combination of two or more kinds thereof.

The acetylene glycol-based surfactant is not particularly limited and, for example, one or more kinds selected from 2,4,7,9-tetramethyl-5-decyne-4,7-diol and an alkylene oxide adduct of 2,4,7,9-tetramethyl-5-decyne-4,7-diol and 2,4-dimethyl-5-decyne-4-ol and an alkylene oxide adduct of 2,4-dimethyl-5-decyne-4-ol are preferable. Commercially-available items of the fluorine-based surfactant are not particularly limited and, for example, Olefin 104 series, PD series, such as Olefin PD002W, E series, such as Olefin E1010 (Trade Names, manufactured by Air Products Japan, INC.), Surfynol 465 and Surfynol 61 (Trade Names, manufactured by Nissin Chemical Industry CO., Ltd.), and the like are mentioned. The acetylene glycol-based surfactants may be used alone or in combination of two or more kinds thereof.

The fluorine-based surfactant is not particularly limited and, for example, perfluoroalkyl sulfonate, perfluoroalkyl carboxylate, perfluoroalkyl phosphoric acid ester, a perfluoroalkyl ethylene oxide adduct, perfluoroalkyl betaine, and a perfluoroalkyl amine oxide compound are mentioned. Commercially-available items of the fluorine-based surfactant are not particularly limited and, for example, S-144 and S-145 (manufactured by Asahi Glass Co., Ltd.); FC-170C, FC-430, and Fluorad-FC4430 (manufactured by Sumitomo 3M, Inc.); FSO, FSO-100, FSN, FSN-100, and FS-300 (manufactured by Dupont); FT-250 and 251 (manufactured by Neos Co., Ltd.), and the like are mentioned. The fluorine-based surfactants may be used alone or in combination of two or more kinds thereof.

The content of the surfactant is preferably 0.1 to 3 parts by mass, more preferably 0.2 to 2 parts by mass, and still more preferably 0.3 to 1 part by mass based on 100 parts by mass of the printing ink composition.

### Water

Water is not particularly limited and pure water, such as ion exchanged water, ultrafiltration water, reverse osmosis water, and distilled water, or ultrapure water, is preferably used for example. Particularly in water obtained by sterilizing the water above by irradiation with ultraviolet rays, hydrogen peroxide addition, or the like, the generation of mold or bacteria tends to be further prevented over a long period of time.

The content ratio of water is preferably 40 to 90% by mass, more preferably 50 to 85% by mass, and still more preferably 60 to 80% by mass to the total amount of the ink composition.

### Water-Soluble Organic Solvent

The ink composition may also further contain a water-soluble organic solvent. The water-soluble organic solvent is not particularly limited and, for example, polyol compounds and glycol ethers are mentioned.

The polyol compounds are not particularly limited and, for example, polyol compounds (preferably diol compounds) in which the number of carbon atoms in the molecule is 2 or more and 6 or less and which may have one ether bond in the molecule and the like are mentioned. Specific examples thereof include glycerol, ethylene glycol, diethylene glycol, triethylene glycol, propylene glycol, dipropylene glycol, 1,3-propanediol, 1,2-butanediol, 1,3-butanediol, 1,4-butanediol, 2,3-butanediol, 3-methyl-1,3-butanediol, 1,2-pentanediol, 1,5-pentanediol, 2-methyl-2,4-pentanediol, 3-methyl-1,5-pentanediol, 1,2-hexanediol, and 1,6-hexanediol.

The glycol ethers are not particularly limited and, for example, monoalkyl ether of glycol selected from ethylene glycol, diethylene glycol, triethylene glycol, propylene glycol, dipropylene glycol, and tripropylene glycol is preferable. More specifically, triethylene glycol monomethyl ether, triethylene glycol monobutyl ether, dipropylene glycol monopropyl ether, and the like can be preferably mentioned.

### Other Additives

The ink composition may also further contain an antifungal agent, an antioxidant, an ultraviolet absorber, an oxygen absorbent, or a dissolution assistant, and, in addition, other various additives usable in a usual ink as necessary. The various additives may be used alone or in combination of two or more kinds thereof.

### Recording Method

The ink composition according to this embodiment is a printing ink composition. Herein, the “printing ink composition” refers to an ink composition for use in a printing method including fixing the ink composition to a target recording medium by heat treatment, such as heat press, when or after fixing the ink composition to the target recording medium. As the printing method, former known methods are usable without particular limitation and chemical treatment or steam heat treatment may be performed for fixing. When the disperse dye is a sublimation dye having a property of sublimating by heating, sublimation transfer is also included as the printing method. Examples of dyeing methods using such sublimation transfer include, for example, a method including performing printing by an ink jet system using an ink containing a sublimation dye on an intermediate transfer medium having a sheet shape, such as paper, overlapping the intermediate transfer medium on a target recording media, such as cloth, and then performing sublimation transfer by heating, a method performing printing by an ink jet system using an ink for sublimation transfer on a releasable ink receiving layer of a target recording media (film product and the like) provided with the ink receiving layer, heating the same as it is to perform sublimation diffusion dyeing to the target recording medium on a lower layer side thereof, and then releasing the ink receiving layer, and the like.

### Target Recording Medium

The target recording medium is not particularly limited and, for example, cloth (hydrophobic fiber cloth and the like), a resin (plastic) film, paper, glass, metal, pottery, and the like are mentioned. As the target recording medium, those having a sheet shape or a three-dimensional shape, such as a spherical shape or a rectangular parallelepiped shape, may be used.

The intermediate transfer medium is not particularly limited and, for example, a target recording medium having an ink receiving layer (referred to as an ink jet paper, a coated paper, and the like) and the like are usable in addition to paper, such as a plain paper. Among the above, a paper having an ink receiving layer containing inorganic particles, such as silica, is preferable. Thus, an intermediate transfer medium in which blurring and the like are inhibited in a process where the ink composition adhering to the intermediate transfer medium dries can be obtained.

When the target recording medium is cloth, fibers configuring the cloth are not particularly limited and, for example, polyester fibers, nylon fibers, triacetate fibers, diacetate fibers, polyamide fibers, blended products containing two or more kinds of these fibers, and the like are mentioned. Moreover, blended products containing the substances mentioned above with regenerated fibers, such as rayon, or natural fibers, such as cotton, silk, and wool, may be used.

When the target recording medium is a resin (plastic) film, examples of usable resin (plastic) films are not particularly limited, and, for example, a polyester film, a polyurethane film, a polycarbonate film, a polyphenylene sulfide film, a polyimide film, a polyamide imide film, and the like are mentioned. The resin (plastic) film may be a laminate in which a plurality of layers are laminated or may be one containing a gradient material in which the material composition changes in a gradient manner.

### EXAMPLES

Hereinafter, the present invention is more specifically described with reference to Examples and Comparative Examples. The present invention is not particularly limited at all by the following Examples.

### Materials for Ink Compositions

Main materials for ink compositions used in the following Examples and Comparative Examples are as follows.

### Dispersant

Raberin W-40 (Creosote oil sulfonic acid-formalin condensate, manufactured by Daiichi Kogyo Seiyaku Co., Ltd.)
Dispersants 1 to 27 (Refer to the following synthesis examples)

### Disperse Dye

### DY114: C.I. Disperse Yellow 114

### DY82: C.I. Disperse Yellow 82

### DY360: C.I. Disperse Yellow 360

### D025: C.I. Disperse Orange 25

### DY54: C.I. Disperse Yellow 54

### DB359: C.I. Disperse Blue 359

### DR60: C.I. Disperse Red 60

### DY232: C.I. Disperse Yellow 232

### DBr27: C.I. Disperse Brown 27

### Surfactant

BYK348 (silicone-based surfactant, manufactured by BYK

### Chemie Japan, Inc.)

### Solvent

Gly (glycerol)
TEGMME (triethylene glycol monomethyl ether)

### Synthesis Examples: Dispersants 1 to 4

Methylbenzene sulfonic acid and methylbenzene were mixed in an equivalent amount at 1:1 to prepare a mixture in which the entire amount was 1 mol. To the prepared mixture, an aqueous formalin solution was added dropwise at 100° C. over 3 hours under refluxing conditions so that the formalin amount was 1 mol. Thereafter, a condensation reaction was performed for 10 hours, and, finally, an unreacted component and water were removed under conditions of 0.5 atm. and 150° C. to give a dispersant 2. Dispersants 2 to 4 were obtained by the same operation as the operation above, except changing the equivalent amount.

### Synthesis Example: Dispersant 5

A dispersant 5 was obtained by the same operation as that of the dispersant 1, except using cresol sulfonic acid in place of the methylbenzene sulfonic acid and using phenol in place of the methylbenzene.

### Synthesis Example: Dispersant 6

A dispersant 6 was obtained by the same operation as that of the dispersant 1, except using naphthalene sulfonic acid in place of the methylbenzene sulfonic acid and using naphthalene in place of the methylbenzene.

### Synthesis Example: Dispersant 7

A dispersant 7 was obtained by the same operation as that of the dispersant 1, except using methoxynaphthalene sulfonic acid in place of the methylbenzene sulfonic acid and using methoxynaphthalene in place of the methylbenzene.

### Synthesis Example: Dispersant 8

A dispersant 8 was obtained by the same operation as that of the dispersant 1, except using naphtholsulfonic acid in place of the methylbenzene sulfonic acid and using naphthol in place of the methylbenzene.

### Synthesis Example: Dispersant 9

A dispersant 9 was obtained by the same operation as that of the dispersant 1, except using sulfonyl naphthoic acid in place of the methylbenzene sulfonic acid and using naphthoic acid in place of the methylbenzene.

### Synthesis Example: Dispersant 10

A dispersant 10 was obtained by the same operation as that of the dispersant 1, except using sulfonyl naphthoic acid in place of the methylbenzene sulfonic acid and using naphthoic acid in place of the methylbenzene.

### Synthesis Example: Dispersant 11

A dispersant 11 was obtained by the same operation as that of the dispersant 1, except using naphthalene disulfonic acid in place of the methylbenzene sulfonic acid and using naphthalene sulfonic acid in place of the methylbenzene.

### Synthesis Example: Dispersant 12

A dispersant 12 was obtained by the same operation as that of the dispersant 1, except using naphthalene sulfonic acid in place of the methylbenzene sulfonic acid and using naphthalene sulfonic acid in place of the methylbenzene.

### Synthesis Example: Dispersant 13

A dispersant 13 was obtained by the same operation as that of the dispersant 1, except using methylnaphthol in place of the methylbenzene sulfonic acid and using methylnaphthalene in place of the methylbenzene.

### Synthesis Example: Dispersant 14

A dispersant 14 was obtained by the same operation as that of the dispersant 1, except using methyl naphthoic acid in place of the methylbenzene sulfonic acid and using methylnaphthalene in place of the methylbenzene.

### Synthesis Example: Dispersant 15

A dispersant 15 was obtained by the same operation as that of the dispersant 1, except using methylnaphthalene sulfate in place of the methylbenzene sulfonic acid and using methylnaphthalene in place of the methylbenzene.

### Synthesis Example: Dispersant 16

A dispersant 16 was obtained by the same operation as that of the dispersant 1, except using methylnaphthalene trisulfonic acid in place of the methylbenzene sulfonic acid and using methylnaphthalene in place of the methylbenzene.

### Synthesis Example: Dispersant 17

A dispersant 17 was obtained by the same operation as that of the dispersant 1, except using methylnaphthalene sulfonic acid in place of the methylbenzene sulfonic acid and using methylnaphthalene in place of the methylbenzene.

### Synthesis Example: Dispersant 18

A dispersant 18 was obtained by the same operation as that of the dispersant 1, except using methylnaphthalene sulfonic acid in place of the methylbenzene sulfonic acid and using dimethylnaphthalene in place of the methylbenzene.

### Synthesis Example: Dispersant 19

A dispersant 19 was obtained by the same operation as that of the dispersant 1, except using methylnaphthalene sulfonic acid in place of the methylbenzene sulfonic acid and using ethylmethylnaphthalene in place of the methylbenzene.

### Synthesis Example: Dispersant 20

A dispersant 20 was obtained by the same operation as that of the dispersant 1, except using methylnaphthalene sulfonic acid in place of the methylbenzene sulfonic acid and using methylpropyl naphthalene in place of the methylbenzene.

### Synthesis Example: Dispersant 21

A dispersant 21 was obtained by the same operation as that of the dispersant 1, except using methylnaphthalene sulfonic acid in place of the methylbenzene sulfonic acid and using methoxymethylnaphthalene in place of the methylbenzene.

### Synthesis Example: Dispersant 22

A dispersant 22 was obtained by the same operation as that of the dispersant 1, except using methylnaphthalene sulfonic acid in place of the methylbenzene sulfonic acid and using ethoxymethylnaphthalene in place of the methylbenzene.

### Synthesis Example: Dispersant 23

A dispersant 23 was obtained by the same operation as that of the dispersant 1, except using trimethylnaphthalene sulfonic acid in place of the methylbenzene sulfonic acid and using trimethylnaphthalene in place of the methylbenzene.

### Synthesis Example: Dispersant 24

A dispersant 24 was obtained by the same operation as that of the dispersant 1, except using methyl anthracene sulfonic acid in place of the methylbenzene sulfonic acid and using methylanthracene in place of the methylbenzene.

### Synthesis Example: Dispersant 25

A dispersant 25 was obtained by the same operation as that of the dispersant 1, except using methyl phenanthrene sulfonic acid in place of the methylbenzene sulfonic acid and using methylphenanthrene in place of the methylbenzene.

### Synthesis Example: Dispersant 26

A dispersant 26 was obtained by the same operation as that of the dispersant 1, except using tetramethylanthracene sulfonic acid in place of the methylbenzene sulfonic acid and using tetramethylanthracene in place of the methylbenzene.

### Synthesis Example: Dispersant 27

A dispersant 27 was obtained by the same operation as that of the dispersant 1, except using trimethylphenanthrene sulfonic acid in place of the methylbenzene sulfonic acid and using trimethylphenanthrene in place of the methylbenzene.

### Method for Measuring Retention Time (r.t.)

In order to relatively evaluate the polarity of each of the obtained dispersants and the polarity of each of the disperse dyes, the retention time (r.t.) was measured by the following apparatus. Tables 1 to 2 show the results of each dispersant and each disperse dye. The peak top of the component peak of mass spectrometry chromatogram (Ionization method: ESI+/I−) was defined as the retention time.

### Measurement Conditions

Apparatus name: ACQUITY UPLC SYSTEM H-class (manufactured by Waters)
Detector: Mass spectrometer Xevo G2-S QTof (manufactured by Waters)
Used column: ACQUITY UPLC BEH Columns BEH-C18
Particle diameter: 1.7 μm
Filling area: 2.1×100 mm (manufactured by Waters: 186004661)
Developing solvent: Solvent A: 10 mM ammonium bicarbonate aqueous solution
Solvent B: Acetonitrile (for high performance liquid chromatography)

### Separation Conditions (Gradient):

At the time of start Solvent A: 99% Solvent B: 1%

1 minute later Solvent A: 45% Solvent B: 55%

6 minutes later Solvent A: 20% Solvent B: 80%

9 minutes later Solvent A: 6% Solvent B: 94%

The measurement was carried out until the lapse of 15 minutes.

Flow velocity: 0.5 mL/min

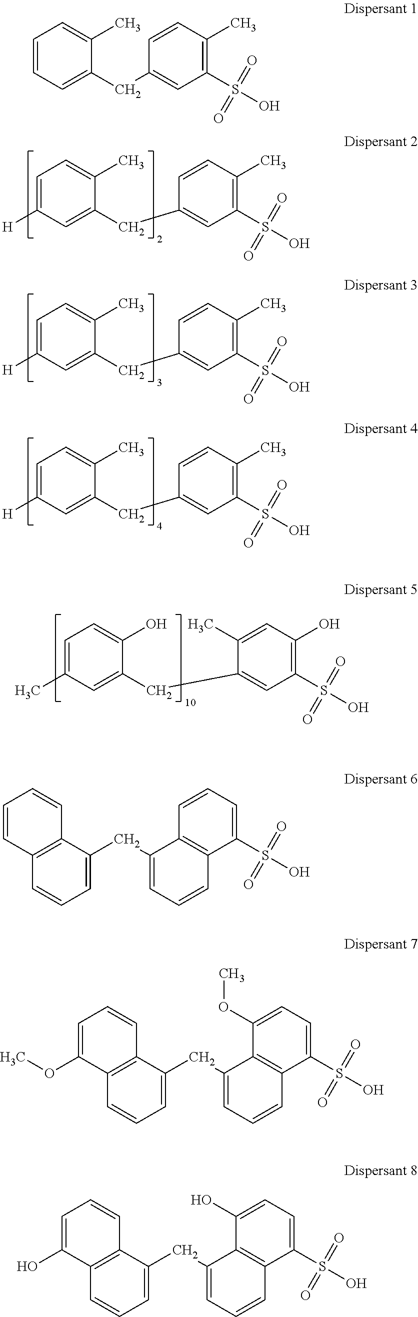

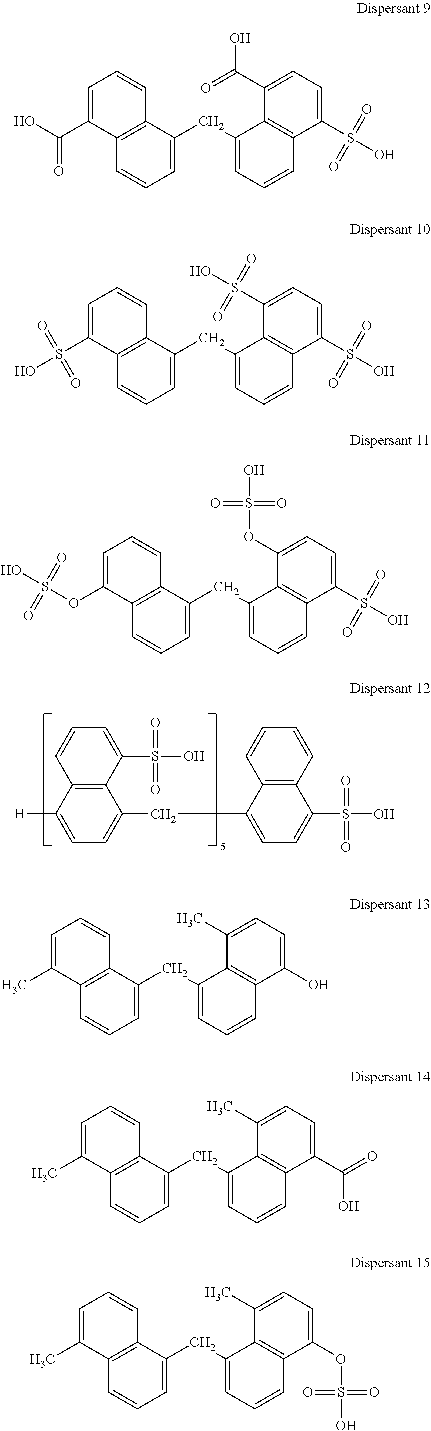

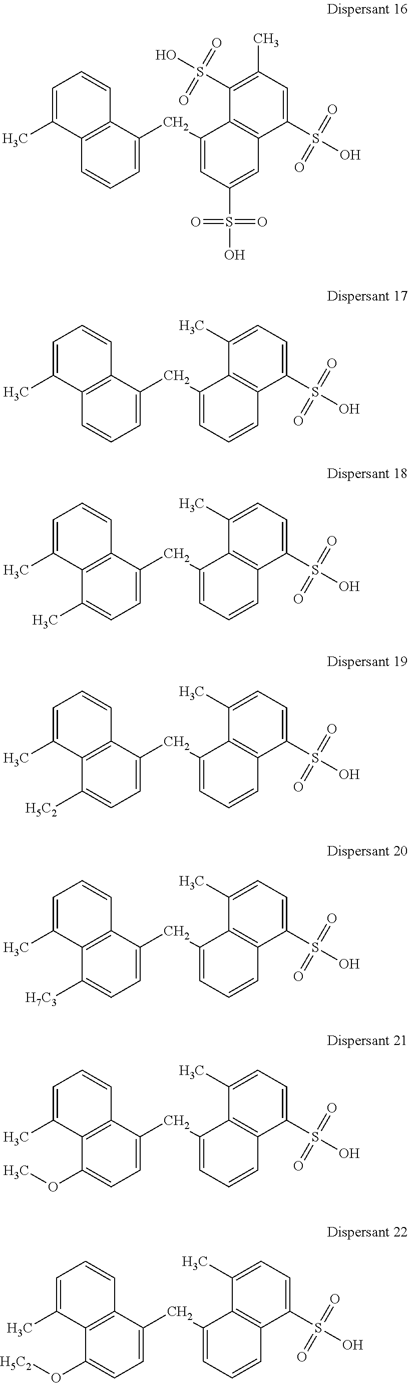

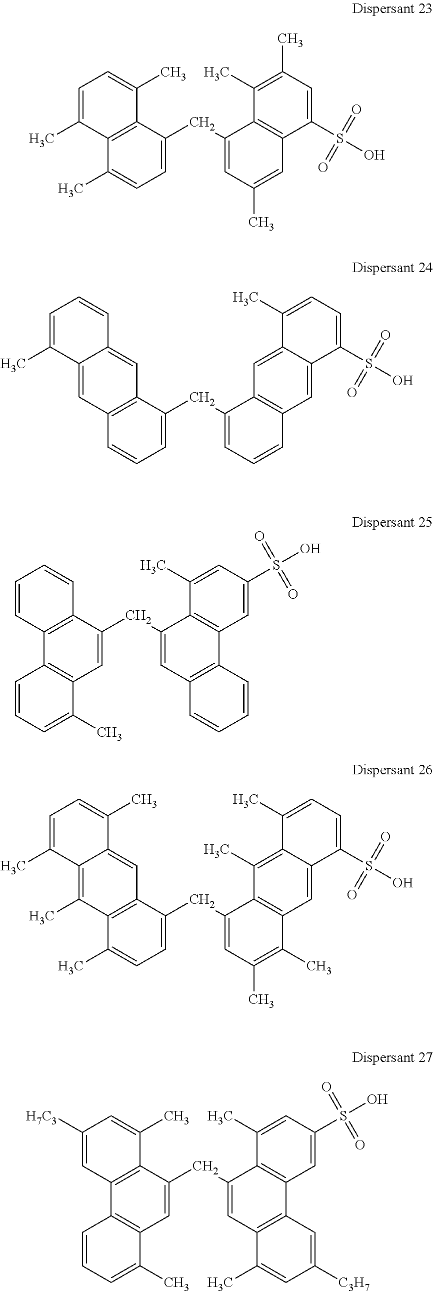

### Preparation of Ink Composition

Materials were mixed according to the composition shown in the following Tables 1 and 2, and then sufficiently stirred to give each ink composition. In the following Table 1 and 2, the unit of the numerical value is % by mass and the total is 100.0% by mass.

TABLE 1

| | | | Examples | | | | | | | | |
|---|---|---|---|---|---|---|---|---|---|---|---|
| | | r.t. | 1 | 2 | 3 | 4 | 5 | 6 | 7 | 8 | 9 |
| Dispersant | Raberin W40 | 1.0-2.5 | 3 | 3 | 2 | 2 | 2 | 2 | 2 | 1.5 | 1.2 |
| | Dispersant 1 | 2.0-4.0 | 3 | 3 | 2 | 2 | 2 | 2 | 2 | 1.5 | 1.2 |
| | Dispersant 2 | 3.0-6.0 | | | 2 | 2 | 2 | 2 | 2 | 1.5 | 1.2 |
| | Dispersant 3 | 5.0-7.5 | | | | | | | | 1.5 | 1.2 |
| | Dispersant 4 | 7.0-8.5 | | | | | | | | | 1.2 |
| Disperse | DY114 | 2.1-2.5 | 5 | | | | | | | | |
| dye | DY82 | 3.3-3.7 | | 5 | | | | | | | |
| | DB360 | 3.9-4.3 | | | 5 | | | | | | |
| | DO25 | 4.2-4.6 | | | | 5 | | | | | |
| | DY54 | 4.4-4.8 | | | | | 5 | | | | |
| | DB359 | 4.4-4.8 | | | | | | 5 | | | |
| | DR60 | 5.3-5.7 | | | | | | | 5 | | |
| | DY232 | 5.7-6.1 | | | | | | | | 5 | |
| | DBr27 | 7.4-7.8 | | | | | | | | | 5 |

| | | | | | | | | | | |
|---|---|---|---|---|---|---|---|---|---|---|
| Surfactant | BYK348 | 0.5 | 0.5 | 0.5 | 0.5 | 0.5 | 0.5 | 0.5 | 0.5 | 0.5 |
| Solvent | Gly | 10 | 10 | 10 | 10 | 10 | 10 | 10 | 10 | 10 |
| | TEGMME | 3 | 3 | 3 | 3 | 3 | 3 | 3 | 3 | 3 |

| Water | | | Balance | Balance | Balance | Balance | Balance | Balance | Balance | Balance | Balance |
|---|---|---|---|---|---|---|---|---|---|---|---|
| Total | | | 100 | 100 | 100 | 100 | 100 | 100 | 100 | 100 | 100 |
| Particle diameter (D50) [nm] | | | 84 | 86 | 86 | 86 | 86 | 86 | 84 | 90 | 83 |
| Ink storageability | | | A | A | A | A | A | A | A | A | A |
| Foreign substance evaluation | | | A | A | A | A | A | A | A | A | A |
| | | | | | | | | | | Comparative | |
| | | | | Examples | | | | | | Examples | |
| | | | r.t. | 10 | 11 | 12 | 13 | 14 | 15 | 1 | 2 |
| | Dispersant | Raberin W40 | 1.0-2.5 | 1 | 1 | 1 | 2 | 2 | | 6 | 6 |
| | | Dispersant 1 | 2.0-4.0 | 1 | 1 | 1 | 2 | | | | |
| | | Dispersant 2 | 3.0-6.0 | 1 | 1 | 1 | | 2 | 3 | | |
| | | Dispersant 3 | 5.0-7.5 | 1 | 1 | 1 | | | 3 | | |
| | | Dispersant 4 | 7.0-8.5 | 1 | 1 | 1 | 2 | 2 | | | |
| | Disperse | DY114 | 2.1-2.5 | 1.5 | | | | 1.5 | | | |
| | dye | DY82 | 3.3-3.7 | | | | | | | 5 | |
| | | DB360 | 3.9-4.3 | | | 1.5 | | | | | |
| | | DO25 | 4.2-4.6 | | | | | | | | |
| | | DY54 | 4.4-4.8 | | 1.5 | 1.5 | | | 1.5 | | |
| | | DB359 | 4.4-4.8 | | 1.5 | | | | 1.5 | | |
| | | DR60 | 5.3-5.7 | 1.5 | 1.5 | | | 1.5 | 1.5 | | |
| | | DY232 | 5.7-6.1 | | | | | | | | |
| | | DBr27 | 7.4-7.8 | 1.5 | | 1.5 | 5 | 1.5 | | | 5 |

| | | | | | | | | | |
|---|---|---|---|---|---|---|---|---|---|
| Surfactant | BYK348 | 0.5 | 0.5 | 0.5 | 0.5 | 0.5 | 0.5 | 0.5 | 0.5 |
| Solvent | Gly | 10 | 10 | 10 | 10 | 10 | 10 | 10 | 10 |
| | TEGMME | 3 | 3 | 3 | 3 | 3 | 3 | 3 | 3 |

| | | | | | | | | |
|---|---|---|---|---|---|---|---|---|
| Water | Balance | Balance | Balance | Balance | Balance | Balance | Balance | Balance |
| Total | 100 | 100 | 100 | 100 | 100 | 100 | 100 | 100 |
| Particle diameter (D50) [nm] | 89 | 83 | 90 | 80 | 90 | 89 | 81 | 81 |
| Ink storageability | A | A | A | B | B | B | C | C |
| Foreign substance evaluation | A | A | A | B | B | B | C | C |

TABLE 2

| | | | Examples | | | | | | | | | | | | | | | | | | | | | | |
|---|---|---|---|---|---|---|---|---|---|---|---|---|---|---|---|---|---|---|---|---|---|---|---|---|---|
| | | r.t. | 16 | 17 | 18 | 19 | 20 | 21 | 22 | 23 | 24 | 25 | 26 | 27 | 28 | 29 | 30 | 31 | 32 | 33 | 34 | 35 | 36 | 37 | 38 |
| Dispersant | Dispersant 5 | 6.0-8.0 | 1.5 | | | | | | | | | | | | | | | | | | | | | | |
| | Dispersant 6 | 2.0-4.0 | | 3 | | | | | | | | | | | | | | | | | | | | | 2 |
| | Dispersant 7 | 2.0-4.0 | | | 3 | | | | | | | | | | | | | | | | | | | | |
| | Dispersant 8 | 2.0-4.0 | | | | 3 | | 2 | 3 | 2 | 2 | 2 | 2 | | | | | | | | | | | 2 | |
| | Dispersant 9 | 1.5-3.5 | | | | | 2 | | | | | | | | | | | | | 2 | | | | | |
| | Dispersant 10 | 1.0-3.0 | | | | | | 2 | | | | | | | | | | | | | | | | | |
| | Dispersant 11 | 1.0-2.5 | | | | | | | 3 | | | | | | | | | | | | | | | | |
| | Dispersant 12 | 1.0-2.5 | 1.5 | 3 | 3 | 3 | 2 | 2 | | 2 | 2 | 2 | 2 | 3 | 3 | 3 | 3 | 3 | 3 | 2 | 2 | 2 | 2 | 2 | 2 |
| | Dispersant 13 | 3.5-5.0 | | | | | | | | 2 | | | | | | | | | | | | | | | |
| | Dispersant 14 | 3.0-5.0 | | | | | | | | | 2 | | | | | | | | | | | | | | |
| | Dispersant 15 | 2.0-3.5 | | | | | | | | | | 2 | | | | | | | | | 2 | 2 | 2 | | |
| | Dispersant 16 | 1.0-2.5 | | | | | | | | | | | 2 | | | | | | | | | | | | |
| | Dispersant 17 | 2.0-4.0 | 1.5 | | | | | | | | | | | 3 | | | | | | | | | | | |
| | Dispersant 18 | 2.0-4.0 | | | | | | | | | | | | | 3 | | | | | | | | | | |
| | Dispersant 19 | 2.0-4.0 | | | | | | | | | | | | | | 3 | | | | | | | | | |
| | Dispersant 20 | 2.0-4.0 | | | | | | | | | | | | | | | 3 | | | | | | | | |
| | Dispersant 21 | 2.0-4.0 | | | | | | | | | | | | | | | | 3 | | | | | | | |
| | Dispersant 22 | 2.0-4.0 | | | | | | | | | | | | | | | | | 3 | | | | | | |
| | Dispersant 23 | 2.5-4.5 | | | | | | | | | | | | | | | | | | 2 | | | | | |
| | Dispersant 24 | 2.5-4.5 | | | | | | | | | | | | | | | | | | | 2 | | | | |
| | Dispersant 25 | 2.5-4.5 | | | | | | | | | | | | | | | | | | | | 2 | | | |
| | Dispersant 26 | 3.0-4.5 | | | | | 2 | | | | | | | | | | | | | | | | 2 | | |
| | Dispersant 27 | 3.5-6.5 | 1.5 | | | | | | | | | | | | | | | | | | | | | 2 | |
| | Raberin W40 | 1.0-2.5 | | | | | | | | | | | | | | | | | | | | | | | 2 |
| Disperse | DY82 | 3.3-3.7 | | 5 | 5 | 5 | 5 | 5 | 5 | | | 5 | 5 | 5 | 5 | 5 | 5 | 5 | 5 | 5 | 5 | 5 | 5 | | 5 |
| dye | DY54 | 4.4-4.8 | 5 | | | | | | | 5 | 5 | | | | | | | | | | | | | 5 | |

| | | | | | | | | | | | | | | | | | | | | | | | | |
|---|---|---|---|---|---|---|---|---|---|---|---|---|---|---|---|---|---|---|---|---|---|---|---|---|
| Surfactant | BYK348 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 |
| Solvent | Gly | 10 | 10 | 10 | 10 | 10 | 10 | 10 | 10 | 10 | 10 | 10 | 10 | 10 | 10 | 10 | 10 | 10 | 10 | 10 | 10 | 10 | 10 | 10 |
| | TEGMME | 3 | 3 | 3 | 3 | 3 | 3 | 3 | 3 | 3 | 3 | 3 | 3 | 3 | 3 | 3 | 3 | 3 | 3 | 3 | 3 | 3 | 3 | 3 |

| | | | | | | | | | | | | | | | | | | | | | | | |
|---|---|---|---|---|---|---|---|---|---|---|---|---|---|---|---|---|---|---|---|---|---|---|---|
| Water | Bal- | Bal- | Bal- | Bal- | Bal- | Bal- | Bal- | Bal- | Bal- | Bal- | Bal- | Bal- | Bal- | Bal- | Bal- | Bal- | Bal- | Bal- | Bal- | Bal- | Bal- | Bal- | Bal- |
| | ance | ance | ance | ance | ance | ance | ance | ance | ance | ance | ance | ance | ance | ance | ance | ance | ance | ance | ance | ance | ance | ance | ance |
| Total | 100 | 100 | 100 | 100 | 100 | 100 | 100 | 100 | 100 | 100 | 100 | 100 | 100 | 100 | 100 | 100 | 100 | 100 | 100 | 100 | 100 | 100 | 100 |
| Particle diameter (D50) [nm] | 89 | 86 | 83 | 87 | 82 | 88 | 80 | 83 | 86 | 85 | 83 | 91 | 87 | 87 | 94 | 94 | 84 | 88 | 86 | 93 | 94 | 94 | 82 |
| Ink storageability | A | A | A | A | A | A | A | A | A | A | A | A | A | A | A | A | A | A | A | A | A | A | A |
| Foreign substance evaluation | A | A | A | A | A | A | A | A | A | A | A | A | A | A | A | A | A | A | A | A | A | A | A |

### Ink Storageability: Particle Diameter Change

100 g of an ink of each of Examples and Comparative Examples was sealed in a glass bottle, and then allowed to stand at 60° C. for 5 days. The volume average particle diameter (D50) of a dispersion substance which was dispersed in the ink was measured before and after the ink was allowed to stand, and then the particle diameter changes before and after the ink was allowed to stand were compared. For the measurement of the volume average particle diameter (D50), Microtrac UPA (manufactured by Nikkiso Co., Ltd.) was used and one obtained by diluting an ink by 1000 times was used as a sample. The particle diameter after the ink was allowed to stand was calculated while setting the particle diameter before the ink was allowed to stand as 100%.

### Evaluation Criteria

A: The particle diameter change after the ink was allowed to stand was less than 120%.
B: The particle diameter change after the ink was allowed to stand was 120% or more and less than 150%.
C: The particle diameter change after the ink was allowed to stand was 150% or more.

### Foreign Substance Evaluation

10 g of an ink of each of Examples and Comparative Examples of Tables 1 to 2 was filtered with a 10 μm membrane filter, hermetically charged into a pack, and then allowed to stand at 60° C. for 5 days. The ink after allowed to stand was filtered with a 10 μm filter, foreign substances originating from the disperse dye collected on the filter was magnified by 100 times with a microscope, and then the number of the foreign substances per cm² was counted.

### Evaluation Criteria

A: The number of the foreign substances was 0 or less.
B: The number of the foreign substances was 1 to 9 or less.
C: The number of the foreign substances was 10 or more.

The entire disclosure of Japanese Patent Application No. 2017-054389, filed Mar. 21, 2017 is expressly incorporated by reference herein.

What is claimed is:

1. A printing ink composition comprising:
a disperse dye;
a dispersant; and
water, wherein
the dispersant contains one or more compounds represented by Formula (1) shown below, 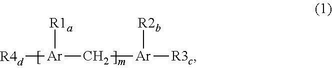
wherein, in Formula 1, Ars each independently represent an aromatic ring having 6 to 24 carbon atoms,
R1 and R2 each independently represent a substituent (an electron attracting group or an electron donating group) selected from the group consisting of H, OCH₃, OH, COOH, SO₃H, OSO₃H, an alkyl group having 1 to 6 carbon atoms, and a salt of H, OCH₃, OH, COOH, SO₃H, OSO₃H, and an alkyl group having 1 to 6 carbon atoms,
R3 represents a substituent (electron attracting group) selected from the group consisting of OH, COOH, SO₃H, OSO₃H, and a salt of OH, COOH, SO₃H, and OSO₃H,
R4 represents a substituent (electron donating group) selected from the group consisting of H, OCH₃, OC₂H₅, an alkyl group having 1 to 3 carbon atoms, and a salt of H, OCH₃, OC₂H₅, and an alkyl group having 1 to 3 carbon atoms,
substituent introduction numbers a, b, c, and d each independently represent an integer of 1 to 8, and
a number of repetitions m represents an integer of 1 to 50.

2. The printing ink composition according to claim 1, wherein
a range of a retention time of the dispersant includes a range from a retention time of 1.5 to an upper limit of the retention time of the disperse dye.

3. The printing ink composition according to claim 1, wherein
a mass ratio (Total dispersant amount/Disperse dye) of a total dispersant amount to the disperse dye is in a range of 1/10 to 10.

4. The printing ink composition according to claim 1, wherein,
the aromatic ring is any one of a benzene ring, a naphthalene ring, an anthracene ring, and a phenanthrene ring.
